(19) United States
(12) Patent Application Publication
(10) Pub. No.: US 2017/0034656 A1
(43) Pub. Date: Feb. 2, 2017

(54) APPARATUS,SYSTEM AND METHOD OF GEOFENCING

(71) Applicant: INTEL CORPORATION, Santa Clara, CA (US)

(72) Inventors: Zhi Gang Wang, Beijing (CN); Jingyi Ma, Beijing (CN); Brian R. Murphy, Beijing (CN)

(21) Appl. No.: 15/300,797

(22) PCT Filed: Jun. 24, 2014
(86) PCT No.: PCT/CN2014/080610

§ 371 Date: Sep. 30, 2016

(51) Int. Cl. H04W 4/02

(52) U.S. Cl. CPC H04W 4/021; H04W 4/028

(57) ABSTRACT

Some demonstrative embodiments include apparatuses, systems and/or methods of geofencing. For example, an apparatus may include a geofencing detector to trigger a first location scan for a first location fix of a mobile device; and a location calculator to dynamically update an activity-based location area of the mobile device relative to the first location fix, based on a plurality of detected activity states of a user of the mobile device, the plurality of detected activity states corresponding to a plurality of detection points subsequent to the first location scan, wherein the geofencing detector is to trigger a second location scan for a second location fix of the mobile device, based on the activity-based location area and a geofencing boundary.

### TECHNICAL FIELD

Embodiments described herein generally relate to geofencing.

### BACKGROUND

Geofencing technology may enable tracking the entering of a mobile device into a predefined geographic area and/or the exiting of the mobile device from the predefined geographic area.

The predefined geographic area may be defined by a point, e.g., a latitude and a longitude, and a radius of a circle around the point (“the geofencing boundary”).

One or more applications may utilize the geofencing technology to provide one or more services to a user of the mobile device. For example, an automated check-in and/or checkout application may utilize the geofencing technology, for example, to subscribe or to unsubscribe a user to a service upon an entrance or an exit of the user from a predefined location.

The geofencing technology may utilize scan operations to detect a location of the mobile device. However, repeatedly performing the scan operations may drain a battery of the mobile device.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements.

The figures are listed below.

FIG. 1 is a schematic block diagram illustration of a system, in accordance with some demonstrative embodiments.

FIG. 2 is a schematic illustration of a scenario of crossing a geofencing boundary, in accordance with some demonstrative embodiments.

FIG. 3 is a schematic illustration of a geofencing detection scenario, in accordance with some demonstrative embodiments.

FIG. 4 is a schematic flow chart illustration of a method of determining when to scan for a location fix of a mobile device, in accordance with some demonstrative embodiments.

FIG. 5 is a schematic flow chart illustration of a method of detecting crossing of a geofencing boundary, in accordance with some demonstrative embodiments.

FIG. 6 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a mobile computer, a laptop computer, a notebook computer, an Ultrabook™ computer, a tablet computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a wireless communication station, a wireless communication device, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The terms “power save” and “power save mode” as used herein may refer, for example, to reducing, diminishing, shutting down, powering off, turning off and/or switching off the electrical current to a device and/or component, and/or to switching the device and/or component to operate at a sleep mode, a reduced-power mode, a stand-by mode, an idle mode and/or any other operation mode, which consumes less power than required for full and/or normal operation of the device and/or component, e.g., for full reception, handling, decoding, transmitting and/or processing of wireless communication signals.

The terms “regular power” and “regular power mode” as used herein may refer, for example, to any operating mode enabling full reception and/or normal operation of a device and/or component, e.g., for full reception, handling, decoding, transmitting and/or processing of wireless communication signals.

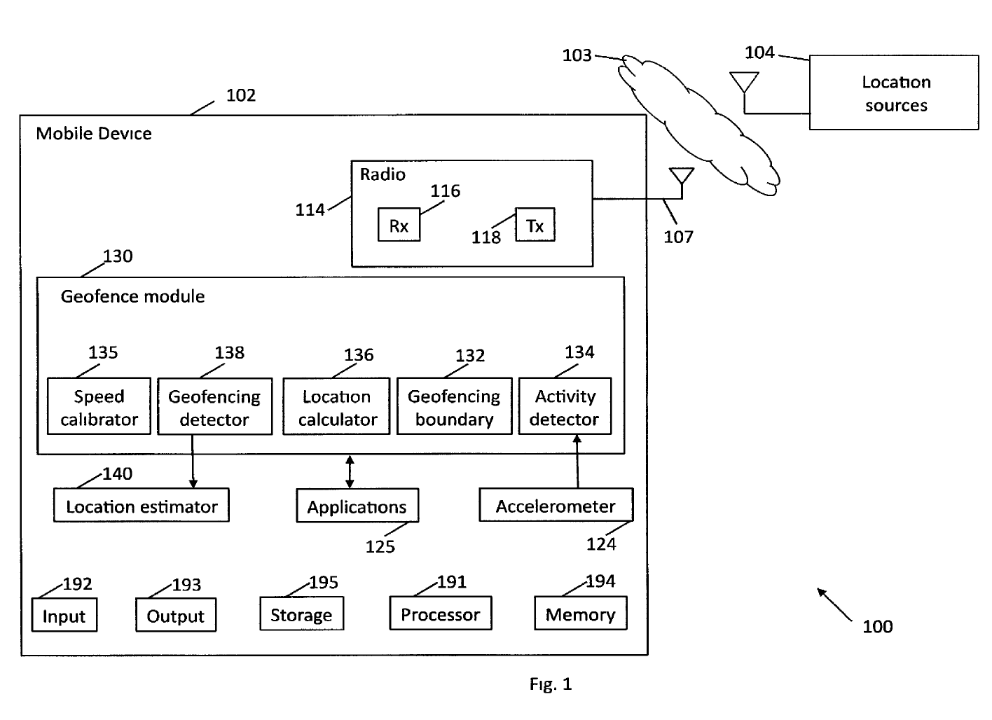

Reference is made to FIG. 1, which schematically illustrates a block diagram of a system 100, in accordance with some demonstrative embodiments.

As shown in FIG. 1, in some demonstrative embodiments, system 100 may include one or more mobile devices, e.g., a mobile device 102.

In some demonstrative embodiments, mobile device 102 may include, for example, a User Equipment (UE), a mobile computer, a laptop computer, a notebook computer, a tablet computer, an Ultrabook™ computer, a mobile internet device, a handheld computer, a handheld device, a storage device, a PDA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, mobile device 102 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a Wireless Fidelity (WiFi) channel, an IR channel, a Bluetooth (BT) channel, and the like.

In some demonstrative embodiments, computing device 102 may include at least one radio 114 to perform wireless communication between computing device 102 and one or more other wireless communication devices.

In some demonstrative embodiments, radio 114 may include one or more wireless receivers (Rx) 116, able to receive wireless communication signals, RF signals, frames, blocks, transmission streams, packets, messages, data items, and/or data.

In some demonstrative embodiments, radio 114 may include one or more wireless transmitters (Tx) 118, able to send wireless communication signals, RF signals, frames, blocks, transmission streams, packets, messages, data items, and/or data.

In some demonstrative embodiments, radio 114 may include modulation elements, demodulation elements, amplifiers, analog to digital and digital to analog converters, filters, and/or the like. For example, radio 114 may include or may be implemented as part of a wireless Network Interface Card (NIC), and the like.

In some demonstrative embodiments, radio 114 may include, or may be associated with, one or more antennas 107.

Antennas 107 may include any type of antennas suitable for transmitting and/or receiving wireless communication signals, blocks, frames, transmission streams, packets, messages and/or data. For example, antennas 107 may include any suitable configuration, structure and/or arrangement of one or more antenna elements, components, units, assemblies and/or arrays. Antennas 107 may include, for example, antennas suitable for directional communication, e.g., using beamforming techniques. For example, antennas 107 may include a phased array antenna, a multiple element antenna, a set of switched beam antennas, and/or the like. In some embodiments, antennas 107 may implement transmit and receive functionalities using separate transmit and receive antenna elements. In some embodiments, antennas 107 may implement transmit and receive functionalities using common and/or integrated transmit/receive elements.

In some demonstrative embodiments, mobile device 102 may also include, for example, a processor 191, an input unit 192, an output unit 193, a memory unit 194, and/or a storage unit 195. Mobile device 102 may optionally include other suitable hardware components and/or software components. In some demonstrative embodiments, some or all of the components of mobile device 102 may be enclosed in a common housing or packaging, and may be interconnected or operably associated using one or more wired or wireless links. In other embodiments, components of mobile device 102 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of mobile device 102 and/or of one or more suitable applications.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by mobile device 102.

Input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, Cathode Ray Tube (CRT) display unit, one or more audio speakers or earphones, or other suitable output devices.

In some demonstrative embodiments, device 102 may be capable of receiving location information from one or more location sources 104 over wireless medium 103.

In some demonstrative embodiments, location sources 104 may include, for example, GNSS satellites, access points, RF transmitters, cellular base stations, and/or the like.

In some demonstrative embodiments, device 102 may include a location estimator 140 configured to estimate a location of device 102 based on the location information from location sources 104.

In some demonstrative embodiments, location estimator 140 may be configured to perform a location scan for a location fix of mobile device 102, for example, to estimate the location of mobile device 102.

In some demonstrative embodiments, the location scan may scan for location sources 104 to receive the location information.

In some demonstrative embodiments, location estimator 140 may determine the location fix of device 102, for example, by using Time of Flight (ToF) measurements, received signal strength indication (RSSI) measurements, trilateration, and/or any other measurement and/or calculation, based on the location information received from location sources 104.

In some demonstrative embodiments, device 102 may include one or more location-based applications and/or services 125 configured to utilize the location fix of mobile device 102.

In some demonstrative embodiments, applications/services 125 may include geofencing applications/services.

In some demonstrative embodiments, a geofencing application may be configured to perform one or more operations, for example, if a user, which carries mobile device 102, crosses a geofencing boundary of a predefined geographical area.

In some demonstrative embodiments, the predefined geographical area may include a circular area around a geographical point, e.g., having a latitude and a longitude; and the geofencing boundary may include the perimeter of the predefined geographical area. In other embodiments, the predefined geographical area may include any other shape, e.g., a rectangle, a square, and/or the like; and the geofencing boundary may include the perimeter of the predefined geographical area, e.g., a perimeter of the rectangle, and the like.

In one example, the geofencing application may include an automated check-in or check-out application configured to automatically subscribe or unsubscribe a user to a service, a database, and/or the like, for example, upon entrance of the user of device 102 into the predefined geographical area.

In some demonstrative embodiments, device 102 may include a geofencing module 130 configured to alert and/or to notify applications/services 125, for example, if mobile device 102 crosses a geofencing boundary 132.

In some demonstrative embodiments, geofencing boundary 132 may include a perimeter of a predefined geographic area defined by applications/services 125, e.g., a mall, an airport, afield, and/or the like.

In some demonstrative embodiments, geofencing module 130 may detect a crossing of geofencing boundary 132 by device 102, for example, based on the location fix of device 102. For example, geofencing module 130 may determine that mobile device 102 crosses geofencing boundary 132, for example, if the location fix of device 102 is within geofencing boundary 132.

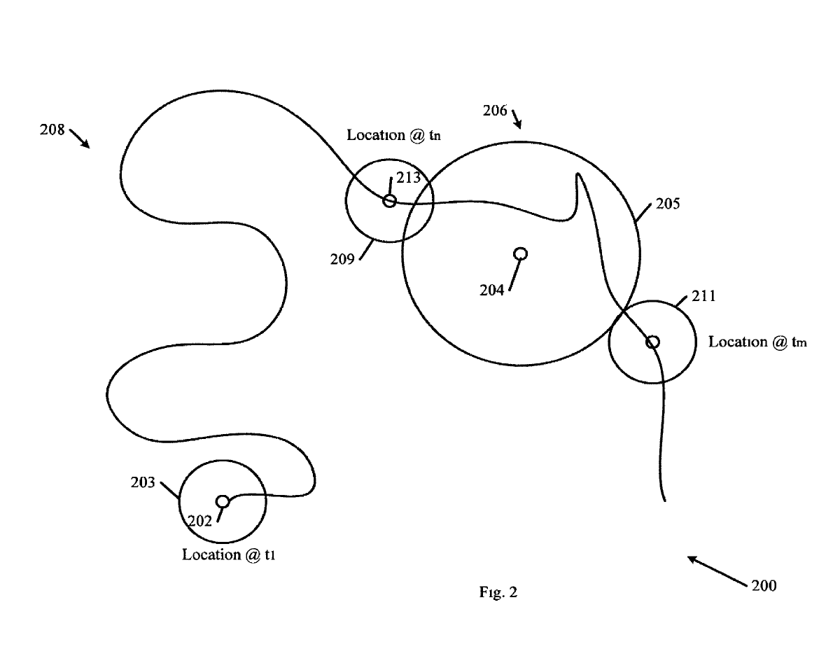

Reference is made to FIG. 2, which schematically illustrates a scenario of crossing a geofence 206 in a geographic region 200.

As shown in FIG. 2, geofence 206 may include a predefined geographic area, which may be defined by a geo point 204, and a radius of a geofencing boundary 205 related to geo point 204.

As shown in FIG. 2, location estimator 140 (FIG. 1) may perform a location scan for a location fix 202 of mobile device 102 (FIG. 1) at a first time, denoted t₁, for example, based on location information from location providers 140 (FIG. 1).

In some demonstrative embodiments, a circle 203 may represent an accuracy of location fix 202. For example, a circular area within circle 203 may represent possible locations of device 102 (FIG. 1), for example, according to a normal distribution statistical function.

As shown in FIG. 2, the user of mobile device 102 (FIG. 1) may move randomly (208) in region 200.

As shown in FIG. 2, location estimator 140 (FIG. 1) may perform a location scan for a location fix 213 of mobile device 102 (FIG. 1) at a second time, denoted tₙ.

As shown in FIG. 2, a circle 209 may represent an accuracy of location fix 213.

As shown in FIG. 2, at the second time tₙ, the user does not cross geofencing boundary 205.

In some demonstrative embodiments, a power consumption of device 102 (FIG. 1) may significantly increase, for example, if device 102 (FIG. 1) performs frequent location scans for the location fix of device 102 (FIG. 1), e.g., to detect the crossing of geofencing boundary 205.

In one example, the frequent location scans may require utilizing an increased amount of resources of device 102 (FIG. 1), e.g., computing resources, communication resources, power resources, and the like.

In some demonstrative embodiments, geofencing module 130 (FIG. 1) may fail to detect crossing of geofencing boundary 205 or may detect the crossing a long period of time after the actual crossing of geofencing boundary 205, for example, if device 102 (FIG. 1) performs infrequent location scans for the location fix of device 102 (FIG. 1).

In one example, geofence module 130 (FIG. 1) may fail to detect the crossing of geofencing boundary 205, for example, if location estimator 140 (FIG. 1) does not perform a location scan for a location fix of mobile device 102 (FIG. 1) until a third time, denoted tₘ, at which, device 102 is located outside geofencing boundary 205.

As shown in FIG. 2, a location fix 211 at time tₘ and location fix 213 may not be within geofence 206. Accordingly, geofence module 130 (FIG. 1) may fail to detect the crossing of geofencing boundary 205, e.g., if a location scan is not performed between the times tₙ and tₘ.

Referring back To FIG. 1, in some demonstrative embodiments, geofence module 130 may trigger location estimator 140 to perform a first location scan for a first location fix of mobile device 102, for example, to determine an estimated location of device 102 relative to geofencing boundary 132.

In some demonstrative embodiments, predicting when to perform a second location scan for a second location fix for mobile device 102, based on a predicted speed of mobile device 102 and a distance between the first location fix and geofencing boundary 132 may not be efficient.

In some demonstrative embodiments, geofencing module 130 may fail to detect crossing of geofencing boundary 132, for example, if geofencing module 130 predicts when to perform the second location scan, based on the predicted speed of mobile device 102 and the distance between the first location fix and geofencing boundary 132.

In one example, predicting the speed of device 102 based on a speed history of device 102 may not be accurate. Therefore, predicting when to perform the second location scan based on the predicted speed of device 102 may not be efficient.

Some demonstrative embodiments may enable predicting when to perform the second location scan for the second location fix based on an activity of the user of mobile device 102, e.g., as described below.

In some demonstrative embodiments, geofence module 130 may include an activity detector 134 (also referred to as an “activity classifier”) to detect a plurality of detected activity states of the user of mobile device 102.

In some demonstrative embodiments, the plurality of detected activity states may correspond to a plurality of detection points subsequent to the first location scan, e.g., as described below.

In some demonstrative embodiments, activity detector 134 may select a detected activity state from a plurality of predefined activity states.

In some demonstrative embodiments, the plurality of predefined activity states may include two or more, e.g., five, activity states. For example, the plurality of predefined activity states may include a stationary state, a walking state, a running state, a biking state, and/or a driving state.

In other embodiments, the plurality of predefined activity states may include one or more additional and/or alternative activity states. For example, a fast walking state, a slow walking state, an urban driving state, a highway driving state, and/or the like.

In some demonstrative embodiments, activity detector 134 may determine the detected activity state based on acceleration information of an accelerometer 124 of device 102.

In one example, activity detector 134 may utilize a decision-tree based activity classifier to determine the detected activity state based on the acceleration information.

In other embodiments, activity detector 134 may determine the detected activity state based on any other information, a module, an activity classification algorithm, and the like.

In one example, activity detector 134 may determine a first detected activity state, e.g., a walking state, based on first acceleration information from accelerometer 124, and/or activity detector 134 may determine a second, e.g., different, detected activity state, e.g., a driving state, based on second, e.g., different, acceleration information from accelerometer 124.

In some demonstrative embodiments, a first power consumption of device 102 to detect the activity state of device 102, e.g., by activity detector 134, may be lesser than a second power consumption to perform the location scan for the location fix of device 102. For example, the second power consumption may be greater than the first power consumption by three orders of magnitude.

In some demonstrative embodiments, the first power consumption may be further reduced, for example, if device 102 includes an external sensor hub, which may enable to offload the detection of the activity state of device 102 to the external sensor hub.

In some demonstrative embodiments, geofence module 130 may include a location calculator 136 configured to dynamically update an activity-based location area of mobile device 102 relative to the first location fix, based on the plurality of detected activity states, e.g., as described below.

In some demonstrative embodiments, geofence module 130 may include a geofencing detector 138 to trigger location estimator 140 to perform the second location scan for the second location fix of mobile device 102, based on the activity-based location area and geofencing boundary 132, e.g., as described below.

In some demonstrative embodiments, geofencing detector 138 may trigger the second location scan, only if the activity-based location area crosses geofencing boundary 132.

In some demonstrative embodiments, location calculator 136 may update the activity-based location area of mobile device 102 relative to the first location fix until the second location scan for the second location fix is triggered, e.g., by geofencing detector 138.

In some demonstrative embodiments, the activity-based location area may include a circular area around the first location fix.

In one example, the circular area may be defined to include possible locations of device 102, e.g., according to a normal distribution statistic function.

In some demonstrative embodiments, location calculator 136 may update the activity-based location area by updating a radius of the circular area.

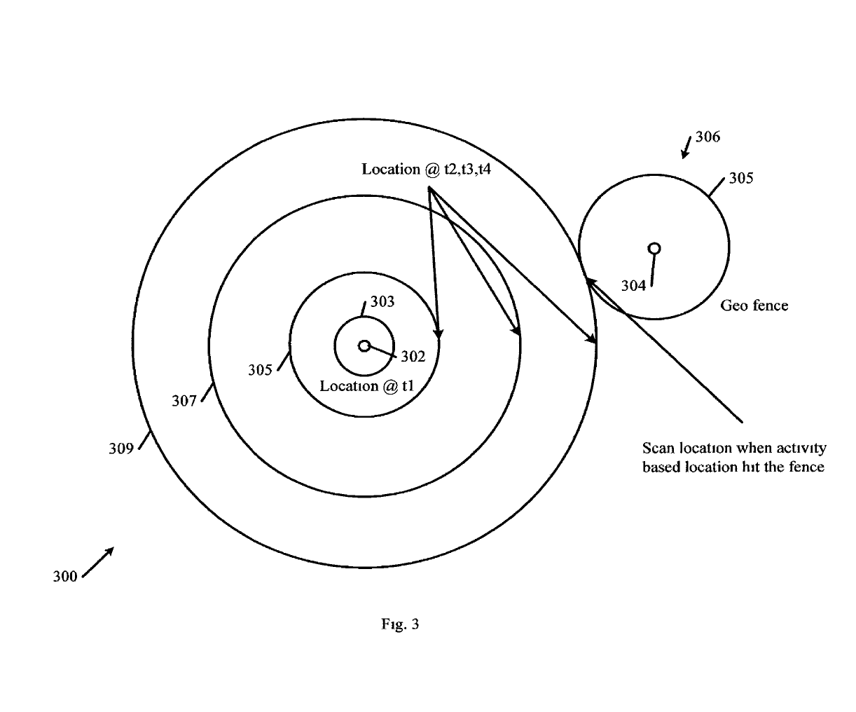

In some demonstrative embodiments, location calculator 136 may update the activity-based location area by monotonously increasing the activity-based location area. For example, location calculator 136 may update the activity-based location area by monotonously increasing the radius of the circular area, e.g., as described below with reference to FIG. 3.

In some demonstrative embodiments, location calculator 136 may update the activity-based location area based on an activity speed corresponding to the detected activity state.

In some demonstrative embodiments, location calculator 136 may utilize the activity speed, for example, instead of an actual speed of the user.

In some demonstrative embodiments, utilizing the activity speed may be more efficient and/or accurate, for example, if the user of device 102 maintains the same speed, when the user performs the same activity.

In some demonstrative embodiments, the activity speed may include an activity speed from a plurality of activity speeds corresponding to the plurality of the predefined activity states.

In one example, the plurality of predefined activity states may include the stationary state, the walking state, the running state, the biking state, and the driving state. According to this example, the plurality of activity speeds may include a stationary state speed, e.g., a zero speed, a walking state speed, a running state speed, a biking state speed, and a driving state speed.

In one example, location calculator 136 may update the activity-based location area, for example, based on the running state speed, if the detected activity state includes the running state.

In some demonstrative embodiments, location calculator 136 may be configured to update the activity-based location area based on a time interval between a detection point of the detected activity state and another detection point of another detected activity state.

In some demonstrative embodiments, location calculator 136 may update the activity-based location area based on a time interval between a first detection point of a first detected activity state, and a second, e.g., subsequent, detection point, of a second detected activity state. In other embodiments, location calculator 136 may update the activity-based location area based on a time interval between any other two detection points.

In some demonstrative embodiments, the time interval between the first and second subsequent detection points may include a predefined time period, e.g., 1 second (sec). In other embodiments, the time interval may be based on the activity of the user, e.g., a time interval between two different detected activities.

In some demonstrative embodiments, location calculator 136 may update the activity-based location area based on the time interval between the first and second subsequent detection points, and the second detected activity state. In other embodiments, location calculator 136 may update the activity-based location area based on the time interval between the first and second subsequent detection points, and the first detected activity state.

In one example, updating the activity-based location area based on one detected activity state, e.g., the first detected activity state or the second detected activity state, may be efficient and accurate, for example, even if the user changes the activity between the first and second detected activity states. For example, even if the first and second activities are different from another, an error caused by the change of the activity state may not propagate across the time interval between the first and second subsequent detection points.

In some demonstrative embodiments, location calculator 136 may update the activity-based location area by determining an activity speed corresponding to the second detected activity state, multiplying the activity speed by the time interval, and increasing the radius of the circular area by the product of the activity speed and the time interval.

In one example, the time interval may be 1 second (sec), and the detected activity state may include a running state. According to this example, location calculator 136 may update the activity-based location area by multiplying the running state speed, e.g., 4 meters per second (m/s), by the time interval, e.g., 1 sec, and may increase the radius of the circular area by the product, e.g., 4*1=4 meters.

In some demonstrative embodiments, geofencing detector 138 may determine whether or not the activity-based location area crosses geofencing boundary 132, e.g., with respect to each detection point of the plurality of the detection points.

In some demonstrative embodiments, location estimator may 136 may continue to update the activity-based location area by monotonously increasing the radius of the circular area, for example, if, at each detection point, geofencing detector 138 determines that the activity-based location area does not cross geofencing boundary 132.

In some demonstrative embodiments, geofencing detector 138 may trigger the second location scan, e.g., only if geofencing detector 138 determines that the activity-based location area crosses geofencing boundary 132, e.g., as described below with reference to FIG. 3.

Reference is made to FIG. 3, which schematically illustrates a scenario of detecting crossing of a geofence 306 in a geographic region 300, in accordance with some demonstrative embodiments.

As shown in FIG. 3, geofence 306 may include a predefined geographic area, which may be defined by a geo point 304 and a radius of a geofencing boundary 305 around geo point 304.

In some demonstrative embodiments, location estimator 140 (FIG. 1) may perform a first location scan for a first location fix 302 of mobile device 102 (FIG. 1) at a detection point, denoted t₁, for example, based on location information from location providers 140 (FIG. 1).

In some demonstrative embodiments, location calculator 136 (FIG. 1) may determine an activity-based location area 301 relative to location fix 302.

As shown in FIG. 3, activity based location area 301 may be defined by a first radius of a circular area 303 around location fix 302.

In some demonstrative embodiments, circular area 303 may represent an accuracy of location fix 302.

In some demonstrative embodiments, circular area 303 may include possible locations of mobile device 102 (FIG. 1) within circular area 303, for example, according to a normal distribution statistical function.

In some demonstrative embodiments, the user of mobile device 102 may move toward any direction, for example, since device 102 (FIG. 1) may not have any direction information with respect to a direction of the user.

In some demonstrative embodiments, activity detector 134 (FIG. 1) may detect a plurality of activity states of the user corresponding to a plurality of respective detection points, denoted t₂, t₃, and t₄, subsequent to the first location scan at detection point t₁.

In some demonstrative embodiments, location calculator 136 (FIG. 1) may update the circular area of activity-based location area 301, based on the plurality of respective detection points, t₂, t₃, and t₄, e.g., as described below.

As shown in FIG. 3, at detection point t₂, calculator 136 (FIG. 1) may update circular area 303 of activity-based location area 301 to a circular area 305.

As shown in FIG. 3, a second radius of circular area 305 may include a sum of the first radius of circular area 303 and a movement distance, which is based on a detected activity state of the user at detection point t₂ and a time interval between detection points t₁ and t₂.

In one example, circular area 305 may include possible locations of mobile device 102 (FIG. 1), for example, according to the normal distribution statistical function. However, circular area 305 is enlarged compared to circular area 303, accordingly, the possible locations of device 102 may be increased.

As shown in FIG. 3, at detection point t3, calculator 136 (FIG. 1) may update the circular area 305 of activity-based location area 301 to a circular area 307.

As shown in FIG. 3, a third radius of circular area 307 may include a sum of the second radius of circular area 305 and a movement distance, which is based on a detected activity state of the user at detection point t₃ and a time interval between detection points t₂ and t₃.

As shown in FIG. 3, at detection point t₄, calculator 136 (FIG. 1) may update the circular area 307 of activity-based location area 301 to a circular area 309.

As shown in FIG. 3, a fourth radius of activity-based location area 309 may include a sum of the third radius of circular area 307 and a movement distance, which is based on a detected activity state of the user at detection point t₄ and a time interval between detection point t₃ and t₄.

In some demonstrative embodiments, location calculator 136 (FIG. 1) may determine the move distance of the user based on an activity speed corresponding to the detected activity state detected at each point of detection points t₂, t₃, and t₄.

As shown in FIG. 3, location calculator 136 (FIG. 1) may update the circular area of the activity-based location area 301 by monotonously increasing a radius of activity-based location area 301.

In some demonstrative embodiments, geofencing detector 138 (FIG. 1) may determine at each detection point of detection points t₁, t₂, t₃, and t₄ whether or not activity based location area 301 crosses geofencing boundary 305.

As shown in FIG. 3, at detection points t₁, t₂, and t₃, activity-based location area 301 does not cross geofencing boundary 305.

AS shown in FIG. 3, at detection point t₄, activity-based location area 301 crosses geofencing boundary 305.

In some demonstrative embodiments, geofencing detector 138 (FIG. 1) may trigger a second location scan for a second location fix, e.g., at time t₄, for example, to determine an estimated location of device 102 (FIG. 1) within activity-based location area 301.

In some demonstrative embodiments, geofencing module 130 (FIG. 1) may switch to a power save mode during a time period between detection points t₁, t₂, t₃, and t₄.

In some demonstrative embodiments, geofencing module 130 (FIG. 1) may switch to a regular power mode at detection points t₁, t₂, t₃, and t₄, for example, to enable activity detector 134 (FIG. 1) to detect a detected activity state of device 102 (FIG. 1).

In some demonstrative embodiments, switching to the power save mode during time periods between the detection points may enable to reduce the power consumption of device 102 (FIG. 1).

In some demonstrative embodiments, experimental results show that using activity-based location area 301 may guarantee detection of at least 93 percent of fence crossing events within two minutes of the crossing events, and detection of 100 percent of fence crossing events within 10 minutes of the crossing events, with reduced power consumption. In contrast, according to the experimental results, when operated at the reduced power consumption, conventional techniques of geofencing may only guarantee a detection of 56 percent of the fence crossing events within two minutes.

In some demonstrative embodiments, a comparison between the method described above and a conventional method, e.g., based on the predicted speed, to detect when device 102 (FIG. 1) crosses geofencing boundary 305, when both methods utilizing substantially the same power consumption level, shows that the method described above assure a 93 percent of fence detection events reported, compared to a 56 percent of fence detection events reported in the conventional method.

Referring back to FIG. 1, in some demonstrative embodiments, geofencing module may include a speed calibrator 135 to estimate an estimated speed of the user of mobile device 102 corresponding to the predefined activity state.

In some demonstrative embodiments, speed calibrator 135 may calibrate (“activity speed calibration”) the activity speed associated with the predefined activity state based on the estimated speed, e.g., as described below.

In one example, speed calibrator 135 may estimate an estimated running speed of the user of mobile device 102 corresponding to the running state, and may calibrate the running state speed based on the estimated running speed of the user.

In another example, speed calibrator 135 may estimate an estimated walking speed of the user of mobile device 102 corresponding to the walking state, and may calibrate the walking state speed based on the estimated walking speed of the user.

In some demonstrative embodiments, speed calibrator 135 may be configured to provide a relatively accurate speed prediction for each activity state of the plurality of predefined activity states.

In some demonstrative embodiments, speed calibrator 135 may initially utilize a predefined speed for each activity of the plurality of predefined activity states. For example, speed calibrator 135 may set a predefined running speed of 3 m/s of the running state, and a predefined walking speed of 1 m/s of the walking state.

In some demonstrative embodiments, speed calibrator 135 may determine an estimated speed for a predefined activity state based on first and a second subsequent location fix values and a time interval between acquiring the two subsequent location fix values.

In some demonstrative embodiments, speed calibrator 135 may utilize the two subsequent location fix values for the activity speed calibration, for example, only if a first detected activity state at the first location fix is equal to a second detected activity state at the second location fix, e.g., to ensure that the user of device 102 is performing the same activity at the time of acquiring the two subsequent location fix values.

In one example, speed calibrator 135 may determine the estimated speed, denoted S₀, based on a distance between the two subsequent location fix values, and the time interval, e.g., as follows:

Sₒ=Distance(Lcur→center,Lp→center)/(t_{cur}−tₚ) (1)

wherein, Lcur→center denotes the second location fix, Lp→center denotes first location fix, t_{cur} denotes a time of the second location fix, and tₚ denotes a time of the first location fix.

In some demonstrative embodiments, speed calibrator 135 may determine an error, denoted eₒ, of the estimated speed, based on an accuracy of the first and second subsequent location fix values, and the time interval between acquiring the two subsequent location fix values, e.g., as follows:

eₒ=Distance(Lcur→accuracy,Lp→accuracy)/(t_{cur}−tₚ) (2)

wherein, Lcur→accuracy denotes an accuracy of the second location fix, and Lp→accuracy denotes an accuracy of the first location fix.

In some demonstrative embodiments, speed calibrator 135 may include a Kalman Filter to determine the activity speed (“calibrated speed”) for the predefined activity state. In other embodiments, speed calibrator 135 may utilize any other methods and/or algorithms to determine the calibrated speed.

In some demonstrative embodiments, speed calibrator 135 may initially input into the Kalman Filter an estimated speed and the predefined speed of the predefined activity state.

In some demonstrative embodiments, speed calibrator 135 may input into the Kalman Filter the estimated speed and a previously calibrated speed, for example, if speed calibrator 135 previously performs the activity speed calibration.

In some demonstrative embodiments, the Kalman Filter may output the calibrated state speed and an error of the calibrated speed.

In one example, speed calibrator 135 may determine the calibrated speed, denoted s_{cal}, based on the estimated speed sₒ, the estimated speed error e₀, a previously calibrated speed or the predefined speed, denoted sₚ, and an error of the previously calibrated speed, denoted eₚ, e.g., as follows:

$${S}_{cal} = Sp + \sqrt{\frac{{e}_{p}^{2}}{{e}_{o}^{2} + {e}_{p}^{2}}} * ( {S}_{o} - {S}_{p} ) \qquad ( 3 )$$

In some demonstrative embodiments, speed calibrator 135 may utilize the value of calibrated speed s_{cal} as the previously calibrated speed sₚ in Equation 3, for a subsequent calculation of a subsequent calibrated speed, for example, if the calibrated speed and the subsequent calibrated speed correspond to the same activity state.

In some demonstrative embodiments, speed calibrator 135 may determine an error, denoted e_{cal}, of the calibrated speed s_{cal} based on the estimated speed error e₀, and an error of the previously calibrated speed eₚ, e.g., as follows:

$${e}_{cal} = \sqrt{( 1 - \sqrt{\frac{{e}_{p}^{2}}{{e}_{o}^{2} + {e}_{p}^{2}}} ) * {e}_{p} 2} \qquad ( 4 )$$

In some demonstrative embodiments, speed calibrator 135 may utilize the value of the error of the calibrated speed e_{cal} as the error of the previously calibrated speed eₚ in Equation 4, for a subsequent calculation of an error of a subsequent calibrated speed, for example, if the calibrated speed and the subsequent calibrated speed correspond to the same activity state.

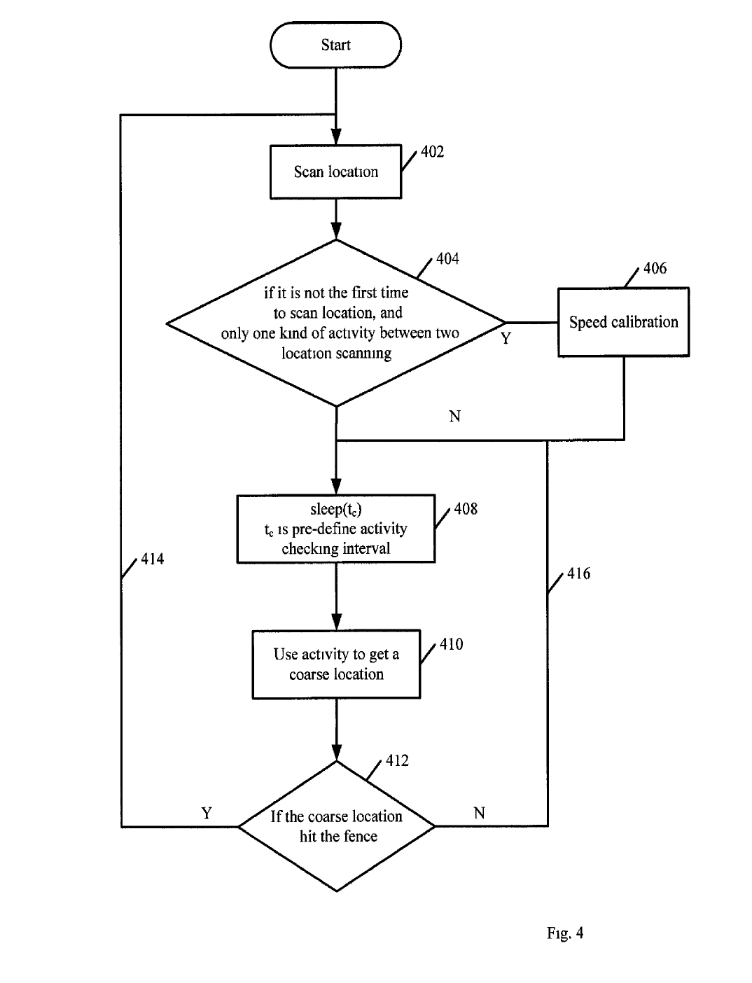

Reference is made to FIG. 4, which schematically illustrates a method of determining when to scan for a location fix of a mobile device, in accordance with some demonstrative embodiments. In some embodiments, one or more of the operations of the method of FIG. 4 may be performed by a system, e.g., system 100 (FIG. 1), a mobile device, e.g., device 102 (FIG. 1), a geofence module, e.g., geofence module 130 (FIG. 1), an activity detector, e.g., activity detector 134 (FIG. 1), a speed calibrator, e.g., speed calibrator 135 (FIG. 1), a geofencing detector, e.g., geofencing detector 138 (FIG. 1), and/or a location estimator, e.g., location estimator 140 (FIG. 1).

As indicated at block 402, the method may include scanning for a first location fix. For example, location estimator 140 (FIG. 1) may scan for the first location fix, e.g., as described above.

As indicated at block 404, the method may include determining whether or not a previous detected activity state of a previous scan for location fix is equal to a first detected activity state of the first location fix. For example, speed calibrator 135 (FIG. 1) may determine whether or not the two subsequent location fix values correspond to the same detected activity state, e.g., as described above.

As indicated at block 406, the method may include performing an activity speed calibration, for example, if two subsequent location fix values correspond to the same detected activity state. For example, speed calibrator 135 (FIG. 1) may calibrate the activity speed associated with the detected activity state, for example, if the two subsequent location fix values correspond to the same detected activity state, e.g., as described above.

As indicated at block 408, the method may include switching to a power save mode between two subsequent detection points for a predefined time interval. For example, geofence module 130 (FIG. 1) may switch to the power save mode between two subsequent detection points, e.g., as described above.

As indicated at block 410, the method may include using a detected activity state to update an activity-based location area. For example, location calculator 136 (FIG. 1) may update the activity-based location area, based on the detected activity state, e.g., as described above.

As indicated at block 412, the method may include determining whether or not the activity-based location area crosses a geofencing boundary. For example, geofencing detector 138 (FIG. 1) may determine whether or not the activity-based location area crosses geofencing boundary 132 (FIG. 1), e.g., as described above.

As indicated by arrow 414, the method may include triggering a second location scan for a second location fix, e.g., if the activity-based location area crosses the geofencing boundary. For example, geofencing detector 138 may trigger location estimator 140 (FIG. 1) to perform the second location scan for the second location fix, for example, if the activity-based location area crosses geofencing boundary 132 (FIG. 1), e.g., as described above.

As indicated by arrow 416, the method may include switching to the power save mode until a subsequent detection point, e.g., if the activity-based location area not crosses the geofencing boundary. For example, geofence module 130 (FIG. 1) may switch to the power save mode until the subsequent detection point, for example, if the activity-based location area does not cross the geofencing boundary 132 (FIG. 1), e.g., as described above.

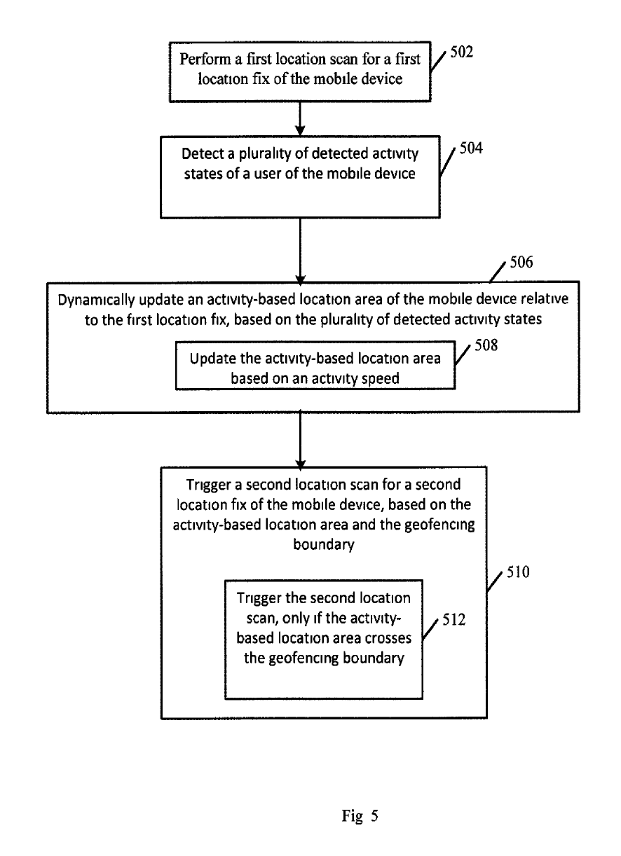

Reference is made to FIG. 5, which schematically illustrates a method of detecting crossing of a geofencing boundary, in accordance with some demonstrative embodiments. In some embodiments, one or more of the operations of the method of FIG. 5 may be performed by a system, e.g., system 100 (FIG. 1), a mobile device, e.g., device 102 (FIG. 1), a geofence module, e.g., geofence module 130 (FIG. 1), an activity detector, e.g., activity detector 134 (FIG. 1), a speed calibrator, e.g., speed calibrator 135 (FIG. 1), a geofencing detector, e.g., geofencing detector 138 (FIG. 1), and/or a location estimator, e.g., location estimator 140 (FIG. 1).

As indicated at block 502, the method may include performing a first location scan for a first location fix of the mobile device. For example, location estimator 140 (FIG. 1) may scan for the first location fix of mobile device 102 (FIG. 1), e.g., as described above.

As indicated at block 504, the method may include detecting a plurality of detected activity states of a user of the mobile device, the plurality of detected activity states corresponding to a plurality of detection points subsequent to the first location scan. For example, activity detector 134 (FIG. 1) may detect the plurality of detected activity states of the user of mobile device 102 (FIG. 1), e.g., as described above.

As indicated at block 506, the method may include dynamically updating an activity-based location area of the mobile device relative to the first location fix, based on the plurality of detected activity states. For example, location calculator 136 (FIG. 1) may dynamically update the activity-based location area of mobile device 102 (FIG. 1) relative to the first location fix, e.g., as described above.

As indicated at block 508, dynamically updating the activity-based location area may include updating the activity-based location area based on an activity speed corresponding to a detected activity state. For example, location calculator 136 (FIG. 1) may update the activity-based location area of mobile device 102 (FIG. 1) based on the activity speed corresponding to the detected activity state, e.g., as described above.

As indicated at block 510, the method may include triggering a second location scan for a second location fix of the mobile device, based on the activity-based location area and the geofencing boundary. For example, geofencing detector 138 (FIG. 1) may trigger the second location scan for the second location fix of mobile device 102 (FIG. 1), based on the activity-based location area and geofencing boundary 132 (FIG. 1), e.g., as described above.

As indicated at block 512, triggering the second location scan may include triggering the second location scan, only if the activity-based location area crosses the geofencing boundary. For example, geofencing detector 138 (FIG. 1) may trigger the second location scan for the second location fix of mobile device 102 (FIG. 1), only if the activity-based location area crosses geofencing boundary 132 (FIG. 1), e.g., as described above.

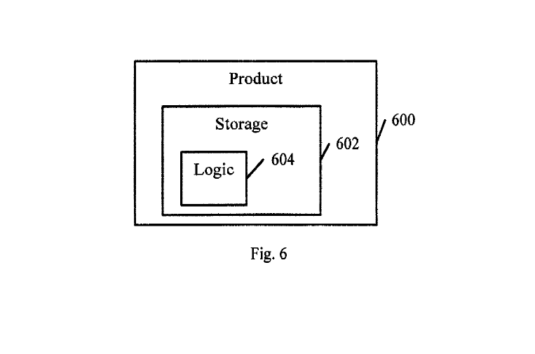

Reference is made to FIG. 6, which schematically illustrates a product of manufacture 500, in accordance with some demonstrative embodiments. Product 600 may include a non-transitory machine-readable storage medium 602 to store logic 604, which may be used, for example, to perform at least part of the functionality of mobile device 102 (FIG. 1), geofence module 130 (FIG. 1), activity detector 134 (FIG. 1), speed calibrator 135 (FIG. 1), geofencing detector 138 (FIG. 1), location estimator 140 (FIG. 1), and/or to perform one or more operations of the methods of FIGS. 4 and/or 5. The phrase “non-transitory machine-readable medium” is directed to include all computer-readable media, with the sole exception being a transitory propagating signal.

In some demonstrative embodiments, product 600 and/or machine-readable storage medium 602 may include one or more types of computer-readable storage media capable of storing data, including volatile memory, non-volatile memory, removable or non-removable memory, erasable or non-erasable memory, writeable or re-writeable memory, and the like. For example, machine-readable storage medium 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes an apparatus comprising a geofencing detector to trigger a first location scan for a first location fix of a mobile device; and a location calculator to dynamically update an activity-based location area of the mobile device relative to the first location fix, based on a plurality of detected activity states of a user of the mobile device, the plurality of detected activity states corresponding to a plurality of detection points subsequent to the first location scan, wherein the geofencing detector is to trigger a second location scan for a second location fix of the mobile device, based on the activity-based location area and a geofencing boundary.

Example 2 includes the subject matter of Example 1, and optionally, wherein the geofencing detector is to trigger the second location scan, only if the activity-based location area crosses the geofencing boundary.

Example 3 includes the subject matter of Example 1 or 2, and optionally, wherein the location calculator is to update the activity-based location area of the mobile device relative to the first location fix until the second location scan is triggered.

Example 4 includes the subject matter of any one of Examples 1-3, and optionally, wherein the activity-based location area comprises a circular area around the first location fix, the location calculator to update the activity-based location area by updating a radius of the circular area.

Example 5 includes the subject matter of any one of Examples 1-4, and optionally, wherein the location calculator is to update the activity-based location area by monotonously increasing the activity-based location area.

Example 6 includes the subject matter of any one of Examples 1-5, and optionally, wherein the location calculator is to update the activity-based location area based on an activity speed corresponding to a detected activity state.

Example 7 includes the subject matter of Example 6, and optionally, wherein the location calculator is to update the activity-based location area based on a time interval between a detection point of the detected activity state and another detection point of another detected activity state.

Example 8 includes the subject matter of Example 6 or 7, and optionally, wherein the detected activity state comprises a predefined activity state selected from a plurality of predefined activity states, and the activity speed corresponding to the detected activity state comprises an activity speed associated with the predefined activity state.

Example 9 includes the subject matter of Example 8, and optionally, wherein the plurality of predefined activity states comprise two or more activity states selected from the group consisting of a stationary state, a walking state, a running state, a biking state, and a driving state.

Example 10 includes the subject matter of Example 8 or 9, and optionally, comprising a speed calibrator to estimate an estimated speed of the user corresponding to the predefined activity state, and to calibrate the activity speed associated with the predefined activity state based on the estimated speed.

Example 11 includes the subject matter of any one of Examples 1-10, and optionally, comprising an activity detector to determine the plurality of detected activity states based on acceleration information of an accelerometer.

Example 12 includes a mobile device comprising one or more antennas; a memory; a processor; a location estimator to perform a first location scan for a first location fix of the mobile device; an activity detector to detect a plurality of detected activity states of a user of the mobile device, the plurality of detected activity states corresponding to a plurality of detection points subsequent to the first location scan; a location calculator to dynamically update an activity-based location area of the mobile device relative to the first location fix, based on the plurality of detected activity states; and a geofencing detector to trigger the location estimator to perform a second location scan for a second location fix of the mobile device, based on the activity-based location area and a geofencing boundary.

Example 13 includes the subject matter of Example 12, and optionally, wherein the geofencing detector is to trigger the second location scan, only if the activity-based location area crosses the geofencing boundary.

Example 14 includes the subject matter of Example 12 or 13, and optionally, wherein the location calculator is to update the activity-based location area of the mobile device relative to the first location fix until the second location scan is triggered.

Example 15 includes the subject matter of any one of Examples 12-14, and optionally, wherein the activity-based location area comprises a circular area around the first location fix, the location calculator to update the activity-based location area by updating a radius of the circular area.

Example 16 includes the subject matter of any one of Examples 12-15, and optionally, wherein the location calculator is to update the activity-based location area by monotonously increasing the activity-based location area.

Example 17 includes the subject matter of any one of Examples 12-16, and optionally, wherein the location calculator is to update the activity-based location area based on an activity speed corresponding to a detected activity state.

Example 18 includes the subject matter of Example 17, and optionally, wherein the location calculator is to update the activity-based location area based on a time interval between a detection point of the detected activity state and another detection point of another detected activity state.

Example 19 includes the subject matter of Example 17 or 18, and optionally, wherein the detected activity state comprises a predefined activity state selected from a plurality of predefined activity states, and the activity speed corresponding to the detected activity state comprises an activity speed associated with the predefined activity state.

Example 20 includes the subject matter of Example 19, and optionally, wherein the plurality of predefined activity states comprise two or more activity states selected from the group consisting of a stationary state, a walking state, a running state, a biking state, and a driving state.

Example 21 includes the subject matter of Example 19 or 20, and optionally, comprising a speed calibrator to estimate an estimated speed of the user corresponding to the predefined activity state, and to calibrate the activity speed associated with the predefined activity state based on the estimated speed.

Example 22 includes the subject matter of any one of Examples 12-21 wherein the activity detector is to determine the plurality of detected activity states based on acceleration information of an accelerometer.

Example 23 includes a method performed by a mobile device to detect crossing of a geofencing boundary, the method comprising performing a first location scan for a first location fix of the mobile device; detecting a plurality of detected activity states of a user of the mobile device, the plurality of detected activity states corresponding to a plurality of detection points subsequent to the first location scan; dynamically updating an activity-based location area of the mobile device relative to the first location fix, based on the plurality of detected activity states; and based on the activity-based location area and the geofencing boundary, triggering a second location scan for a second location fix of the mobile device.

Example 24 includes the subject matter of Example 23, and optionally, comprising triggering the second location scan, only if the activity-based location area crosses the geofencing boundary.

Example 25 includes the subject matter of Example 23 or 24, and optionally, comprising updating the activity-based location area of the mobile device relative to the first location fix until the second location scan is triggered.

Example 26 includes the subject matter of any one of Examples 23-25, and optionally, wherein the activity-based location area comprises a circular area around the first location fix, and wherein updating the activity-based location area comprises updating a radius of the circular area.

Example 27 includes the subject matter of any one of Examples 23-26, and optionally, comprising updating the activity-based location area by monotonously increasing the activity-based location area.

Example 28 includes the subject matter of any one of Examples 23-27, and optionally, comprising updating the activity-based location area based on an activity speed corresponding to a detected activity state.

Example 29 includes the subject matter of Example 28, and optionally, comprising updating the activity-based location area based on a time interval between a detection point of the detected activity state and another detection point of another detected activity state.

Example 30 includes the subject matter of Example 28 or 29, and optionally, wherein the detected activity state comprises a predefined activity state selected from a plurality of predefined activity states, and the activity speed corresponding to the detected activity state comprises an activity speed associated with the predefined activity state.

Example 31 includes the subject matter of Example 30, and optionally, wherein the plurality of predefined activity states comprise two or more activity states selected from the group consisting of a stationary state, a walking state, a running state, a biking state, and a driving state.

Example 32 includes the subject matter of Example 30 or 31, and optionally, comprising estimating an estimated speed of the user corresponding to the predefined activity state, and calibrating the activity speed associated with the predefined activity state based on the estimated speed.

Example 33 includes the subject matter of any one of Examples 23-32, and optionally, comprising detecting the plurality of detected activity states based on acceleration information of an accelerometer.

Example 34 includes a product including one or more tangible computer-readable non-transitory storage media comprising computer-executable instructions operable to, when executed by at least one computer processor, enable the at least one computer processor to implement a method comprising performing a first location scan for a first location fix of a mobile device; detecting a plurality of detected activity states of a user of the mobile device, the plurality of detected activity states corresponding to a plurality of detection points subsequent to the first location scan; dynamically updating an activity-based location area of the mobile device relative to the first location fix, based on the plurality of detected activity states; and based on the activity-based location area and the geofencing boundary, triggering a second location scan for a second location fix of the mobile device.

Example 35 includes the subject matter of Example 34, and optionally, wherein the method comprises triggering the second location scan, only if the activity-based location area crosses the geofencing boundary.

Example 36 includes the subject matter of Example 34 or 35, and optionally, wherein the method comprises updating the activity-based location area of the mobile device relative to the first location fix until the second location scan is triggered.

Example 37 includes the subject matter of any one of Examples 34-36, and optionally, wherein the activity-based location area comprises a circular area around the first location fix, and wherein updating the activity-based location area comprises updating a radius of the circular area.

Example 38 includes the subject matter of any one of Examples 34-37, and optionally, wherein the method comprises updating the activity-based location area by monotonously increasing the activity-based location area.

Example 39 includes the subject matter of any one of Examples 34-38, and optionally, wherein the method comprises updating the activity-based location area based on an activity speed corresponding to a detected activity state.

Example 40 includes the subject matter of Example 39, and optionally, wherein the method comprises updating the activity-based location area based on a time interval between a detection point of the detected activity state and another detection point of another detected activity state.

Example 41 includes the subject matter of Example 39 or 40, and optionally, wherein the detected activity state comprises a predefined activity state selected from a plurality of predefined activity states, and the activity speed corresponding to the detected activity state comprises an activity speed associated with the predefined activity state.

Example 42 includes the subject matter of Example 41, and optionally, wherein the plurality of predefined activity states comprise two or more activity states selected from the group consisting of a stationary state, a walking state, a running state, a biking state, and a driving state.

Example 43 includes the subject matter of Example 41 or 42, and optionally, wherein the method comprises estimating an estimated speed of the user corresponding to the predefined activity state, and calibrating the activity speed associated with the predefined activity state based on the estimated speed.

Example 44 includes the subject matter of any one of Examples 34-43, and optionally, wherein the method comprises detecting the plurality of detected activity states based on acceleration information of an accelerometer.

Example 45 includes an apparatus comprising means for performing a first location scan for a first location fix of a mobile device; means for detecting a plurality of detected activity states of a user of the mobile device, the plurality of detected activity states corresponding to a plurality of detection points subsequent to the first location scan; means for dynamically updating an activity-based location area of the mobile device relative to the first location fix, based on the plurality of detected activity states; and means for triggering a second location scan for a second location fix of the mobile device, based on the activity-based location area and the geofencing boundary.

Example 46 includes the subject matter of Example 45, and optionally, comprising means for triggering the second location scan, only if the activity-based location area crosses the geofencing boundary.

Example 47 includes the subject matter of Example 45 or 46, and optionally, comprising means for updating the activity-based location area of the mobile device relative to the first location fix until the second location scan is triggered.

Example 48 includes the subject matter of any one of Examples 45-47, and optionally, wherein the activity-based location area comprises a circular area around the first location fix, and the means for dynamically updating the activity-based location area comprise means for updating the activity-based location area by updating a radius of the circular area.

Example 49 includes the subject matter of any one of Examples 45-48, and optionally, comprising means for updating the activity-based location area by monotonously increasing the activity-based location area.

Example 50 includes the subject matter of any one of Examples 45-49, and optionally, comprising means for updating the activity-based location area based on an activity speed corresponding to a detected activity state.

Example 51 includes the subject matter of Example 50, and optionally, comprising means for updating the activity-based location area based on a time interval between a detection point of the detected activity state and another detection point of another detected activity state.

Example 52 includes the subject matter of Example 50 or 51, and optionally, wherein the detected activity state comprises a predefined activity state selected from a plurality of predefined activity states, and the activity speed corresponding to the detected activity state comprises an activity speed associated with the predefined activity state.

Example 53 includes the subject matter of Example 52, and optionally, wherein the plurality of predefined activity states comprise two or more activity states selected from the group consisting of a stationary state, a walking state, a running state, a biking state, and a driving state.

Example 54 includes the subject matter of Example 52 or 53, and optionally, comprising means for estimating an estimated speed of the user corresponding to the predefined activity state, and calibrating the activity speed associated with the predefined activity state based on the estimated speed.

Example 55 includes the subject matter of any one of Examples 45-54, and optionally, comprising means for detecting the plurality of detected activity states based on acceleration information of an accelerometer.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

1.-25. (canceled)

26. An apparatus comprising:
a geofencing detector to trigger a first location scan for a first location fix of a mobile device; and
a location calculator to dynamically update an activity-based location area of said mobile device relative to said first location fix, based on a plurality of detected activity states of a user of said mobile device, the plurality of detected activity states corresponding to a plurality of detection points subsequent to said first location scan,
wherein said geofencing detector is to trigger a second location scan for a second location fix of said mobile device, based on said activity-based location area and a geofencing boundary.

27. The apparatus of claim 26, wherein said geofencing detector is to trigger said second location scan, only if said activity-based location area crosses said geofencing boundary.

28. The apparatus of claim 26, wherein said location calculator is to update the activity-based location area of said mobile device relative to said first location fix until said second location scan is triggered.

29. The apparatus of claim 26, wherein said activity-based location area comprises a circular area around said first location fix, said location calculator to update said activity-based location area by updating a radius of said circular area.

30. The apparatus of claim 26, wherein said location calculator is to update said activity-based location area by monotonously increasing said activity-based location area.

31. The apparatus of claim 26, wherein said location calculator is to update said activity-based location area based on an activity speed corresponding to a detected activity state.

32. The apparatus of claim 31, wherein said location calculator is to update said activity-based location area based on a time interval between a detection point of the detected activity state and another detection point of another detected activity state.

33. The apparatus of claim 31, wherein the detected activity state comprises a predefined activity state selected from a plurality of predefined activity states, and the activity speed corresponding to the detected activity state comprises an activity speed associated with said predefined activity state.

34. The apparatus of claim 33, wherein said plurality of predefined activity states comprise two or more activity states selected from the group consisting of a stationary state, a walking state, a running state, a biking state, and a driving state.

35. The apparatus of claim 33 comprising a speed calibrator to estimate an estimated speed of said user corresponding to said predefined activity state, and to calibrate the activity speed associated with said predefined activity state based on the estimated speed.

36. The apparatus of claim 26 comprising an activity detector to determine the plurality of detected activity states based on acceleration information of an accelerometer.

37. A mobile device comprising:
one or more antennas;
a memory;
a processor;
a location estimator to perform a first location scan for a first location fix of said mobile device;
an activity detector to detect a plurality of detected activity states of a user of said mobile device, the plurality of detected activity states corresponding to a plurality of detection points subsequent to said first location scan;
a location calculator to dynamically update an activity-based location area of said mobile device relative to said first location fix, based on said plurality of detected activity states; and
a geofencing detector to trigger said location estimator to perform a second location scan for a second location fix of said mobile device, based on said activity-based location area and a geofencing boundary.

38. The mobile device of claim 37, wherein said geofencing detector is to trigger said second location scan, only if said activity-based location area crosses said geofencing boundary.

39. The mobile device of claim 37, wherein said location calculator is to update the activity-based location area of said mobile device relative to said first location fix until said second location scan is triggered.

40. The mobile device of claim 37, wherein said location calculator is to update said activity-based location area based on an activity speed corresponding to a detected activity state.

41. The mobile device of claim 40, wherein the detected activity state comprises a predefined activity state selected from a plurality of predefined activity states, and the activity speed corresponding to the detected activity state comprises an activity speed associated with said predefined activity state.

42. The mobile device of claim 41 comprising a speed calibrator to estimate an estimated speed of said user corresponding to said predefined activity state, and to calibrate the activity speed associated with said predefined activity state based on the estimated speed.

43. A method performed by a mobile device to detect crossing of a geofencing boundary, the method comprising:
performing a first location scan for a first location fix of said mobile device;
detecting a plurality of detected activity states of a user of said mobile device, the plurality of detected activity states corresponding to a plurality of detection points subsequent to said first location scan;
dynamically updating an activity-based location area of said mobile device relative to said first location fix, based on said plurality of detected activity states; and
based on said activity-based location area and the geofencing boundary, triggering a second location scan for a second location fix of said mobile device.

44. The method of claim 43 comprising triggering said second location scan, only if said activity-based location area crosses said geofencing boundary.

45. The method of claim 43 comprising updating the activity-based location area of said mobile device relative to said first location fix until said second location scan is triggered.

46. A product including one or more tangible computer-readable non-transitory storage media comprising computer-executable instructions operable to, when executed by at least one computer processor, enable the at least one computer processor to implement a method comprising:
performing a first location scan for a first location fix of a mobile device;
detecting a plurality of detected activity states of a user of said mobile device, the plurality of detected activity states corresponding to a plurality of detection points subsequent to said first location scan;
dynamically updating an activity-based location area of said mobile device relative to said first location fix, based on said plurality of detected activity states; and
based on said activity-based location area and the geofencing boundary, triggering a second location scan for a second location fix of said mobile device.

47. The product of claim 46, wherein said method comprises triggering said second location scan, only if said activity-based location area crosses said geofencing boundary.

48. The product of claim 46, wherein said method comprises updating the activity-based location area of said mobile device relative to said first location fix until said second location scan is triggered.

49. The product of claim 46, wherein said activity-based location area comprises a circular area around said first location fix, and wherein updating said activity-based location area comprises updating a radius of said circular area.

50. The product of claim 46, wherein said method comprises updating said activity-based location area based on an activity speed corresponding to a detected activity state.
